(19) United States
(12) Patent Application Publication
(10) Pub. No.: US 2019/0156441 A1
(43) Pub. Date: May 23, 2019

(54) INTERWOVEN GROUP TRIP ITINERARY DEVELOPMENT BASED ON SOCIAL FOOTPRINTS AND CROWDSOURCING

(71) Applicant: International Business Machines Corporation, Armonk, NY (US)

(72) Inventors: Nimesh Bhatia, San Jose, CA (US); Srinivas R. Brahmaroutu, San Jose, CA (US); Seyyed Vahid Hashemian, Redwood City, CA (US); Cindy Han Lu, San Jose, CA (US); Animesh Singh, Santa Clara, CA (US); Thai Quoc Tran, San Jose, CA (US)

(21) Appl. No.: 15/820,488

(22) Filed: Nov. 22, 2017

(51) Int. Cl. G06Q 50/14; G06Q 50/00; G06Q 10/10; G06F 17/30

(52) U.S. Cl. CPC G06Q 50/14; G06F 17/30867; G06Q 10/1095; G06Q 50/01

(57) ABSTRACT

Approaches presented herein enable development of interwoven group trip itineraries based on social media footprints. More specifically, for each member of the group, a travel interests footprint is generated based on his/her social media history. These footprints are mapped together in a semantic web that includes identifiers associated with the interests of the footprints. Activities corresponding to a time and location are obtained and matched based on correlations to the interest-associated identifiers. Based on an association of a group member’ footprint to a semantic web identifier, and from there to an activity, itineraries are built for the members and activities are added to particular members' itineraries in which those members are likely to have an interest. Based on user-defined criteria, activities in the itineraries can be shared by the group as a whole or subgroups may be formed when the itineraries of some group members are assigned different activities.

### TECHNICAL FIELD

The present invention relates generally to developing trip itineraries based on interests and, more specifically, to customizing interwoven trip itineraries to subgroups of people within a group based on leveraged social media footprints revealing shared interests between members of the group.

### BACKGROUND

Planning a vacation or other recreational activities can be hectic and frustrating. Because of this, some people rely on tools and services to help simplify the process. Such tools and services can include, for example, flight and hotel booking websites, such as Priceline and Expedia, and travel route websites, such as Google Maps. Additionally, there are membership services that a person can sign up for to receive assistance with travel logistics, such as AAA. All trademarks and trade names used herein are the property of their respective owners and are used for illustrative and descriptive purposes only.

### SUMMARY

Approaches presented herein enable development of interwoven group trip itineraries based on social media footprints. More specifically, for each member of the group, a travel interests footprint is generated based on his/her social media history. These footprints are mapped together in a semantic web that includes identifiers associated with the interests of the footprints. Activities corresponding to a time and location are obtained and matched based on correlations to the interest-associated identifiers. Based on an association of a group member’ footprint to a semantic web identifier, and from there to an activity, itineraries are built for the members of the group and activities are added to particular members' itineraries in which the particular members are likely to have an interest. Based on user-defined criteria, activities in the itineraries can be shared by the group as a whole or subgroups may be formed when the itineraries of some group members are assigned different activities.

One aspect of the present invention includes a method for developing interwoven group trip itineraries based on social media footprints, the method comprising: generating, for each person of a plurality of people in a group, a travel interests footprint based on a social media history of the person; mapping a first travel interests footprint of a first person of the group to a first identifier in a semantic web associated with a first interest in the first travel interests footprint, the semantic web comprising a plurality of identifiers associated with interests; mapping a second travel interests footprint of a second person of the group to a second identifier in the semantic web associated with a second interest in the second travel interests footprint; obtaining a plurality of activity options based on a provided location and time; performing a correlation between the plurality of activity options and the first and second identifiers in the semantic web; matching, in response to a first correlation value above a threshold, a first activity option of the plurality of activity options to the first identifier and matching, in response to a second correlation value above the threshold, a second activity option of the plurality of activity options to the second identifier; and building a first itinerary for the first person and a second itinerary for the second person by: adding the first activity option to the first itinerary based on the association of the first identifier to the first interest in the first travel interests footprint and on the matching of the first activity option to the first identifier and adding the second activity option to the second itinerary based on the association of the second identifier to the second interest in the second travel interests footprint and on the matching of the second activity option to the second identifier.

Another aspect of the present invention includes a computer system for developing interwoven group trip itineraries based on social media footprints, the computer system comprising: a memory medium comprising program instructions; a bus coupled to the memory medium; and a processor, for executing the program instructions, coupled to a social media footprint-based group itinerary generation engine via the bus that when executing the program instructions causes the system to: generate, for each person of a plurality of people in a group, a travel interests footprint based on a social media history of the person; map a first travel interests footprint of a first person of the group to a first identifier in a semantic web associated with a first interest in the first travel interests footprint, the semantic web comprising a plurality of identifiers associated with interests; map a second travel interests footprint of a second person of the group to a second identifier in the semantic web associated with a second interest in the second travel interests footprint; obtain a plurality of activity options based on a provided location and time; perform a correlation between the plurality of activity options and the first and second identifiers in the semantic web; match, in response to a first correlation value above a threshold, a first activity option of the plurality of activity options to the first identifier and match, in response to a second correlation value above a threshold, a second activity option of the plurality of activity options to the second identifier; and build a first itinerary for the first person and a second itinerary for the second person by: adding the first activity option to the first itinerary based on the association of the first identifier to the first interest in the first travel interests footprint and on the matching of the first activity option to the first identifier and adding the second activity option to the second itinerary based on the association of the second identifier to the second interest in the second travel interests footprint and on the matching of the second activity option to the second identifier.

Yet another aspect of the present invention includes a computer program product for developing interwoven group trip itineraries based on social media footprints, the computer program product comprising a computer readable hardware storage device, and program instructions stored on the computer readable hardware storage device, to: generate, for each person of a plurality of people in a group, a travel interests footprint based on a social media history of the person; map a first travel interests footprint of a first person of the group to a first identifier in a semantic web associated with a first interest in the first travel interests footprint, the semantic web comprising a plurality of identifiers associated with interests; map a second travel interests footprint of a second person of the group to a second identifier in the semantic web associated with a second interest in the second travel interests footprint; obtain a plurality of activity options based on a provided location and time; perform a correlation between the plurality of activity options and the first and second identifiers in the semantic web; match, in response to a first correlation value above a threshold, a first activity option of the plurality of activity options to the first identifier and match, in response to a second correlation value above a threshold, a second activity option of the plurality of activity options to the second identifier; and build a first itinerary for the first person and a second itinerary for the second person by: adding the first activity option to the first itinerary based on the association of the first identifier to the first interest in the first travel interests footprint and on the matching of the first activity option to the first identifier and adding the second activity option to the second itinerary based on the association of the second identifier to the second interest in the second travel interests footprint and on the matching of the second activity option to the second identifier.

Still yet, any of the components of the present invention could be deployed, managed, serviced, etc., by a service provider who offers to implement passive monitoring in a computer system.

Embodiments of the present invention also provide related systems, methods, and/or program products.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings in which:

FIG. 1 shows an architecture in which the invention may be implemented according to illustrative embodiments;

FIG. 2 shows a system diagram describing the functionality discussed herein according to illustrative embodiments;

FIG. 3 shows an illustrative example of leveraging a semantic web to map a social media user's travel interests footprint based on social media according to illustrative embodiments;

FIG. 4 shows a mapping of interests in a semantic web for a travel group of two or more people according to illustrative embodiments;

FIG. 5 shows a matching of interests represented in a semantic web to potential travel activities for a travel group of two or more people according to illustrative embodiments;

FIG. 6 shows a building of trip itineraries for subgroups of members of a travel group of two or more people according to illustrative embodiments; and

FIG. 7 shows a process flowchart for developing interwoven group trip itineraries based on social media footprints according to illustrative embodiments.

The drawings are not necessarily to scale. The drawings are merely representations, not intended to portray specific parameters of the invention. The drawings are intended to depict only typical embodiments of the invention, and therefore should not be considered as limiting in scope. In the drawings, like numbering represents like elements.

### DETAILED DESCRIPTION

Illustrative embodiments will now be described more fully herein with reference to the accompanying drawings, in which illustrative embodiments are shown. It will be appreciated that this disclosure may be embodied in many different forms and should not be construed as limited to the illustrative embodiments set forth herein. Rather, these embodiments are provided so that this disclosure will be thorough and complete and will fully convey the scope of this disclosure to those skilled in the art.

Furthermore, the terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. Furthermore, similar elements in different figures may be assigned similar element numbers. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Unless specifically stated otherwise, it may be appreciated that terms such as “processing,” “detecting,” “determining,” “evaluating,” “receiving,” or the like, refer to the action and/or processes of a computer or computing system, or similar electronic data center device, that manipulates and/or transforms data represented as physical quantities (e.g., electronic) within the computing system's registers and/or memories into other data similarly represented as physical quantities within the computing system's memories, registers or other such information storage, transmission or viewing devices. The embodiments are not limited in this context.

As stated above, embodiments described herein provide for development of interwoven group trip itineraries based on social media footprints. More specifically, for each member of the group, a travel interests footprint is generated based on his/her social media history. These footprints are mapped together in a semantic web that includes identifiers associated with the interests of the footprints. Activities corresponding to a time and location are obtained and matched based on correlations to the interest-associated identifiers in the semantic map. Based on an association of a group member’ footprint to a semantic web identifier, and from there to an activity, itineraries are built for the members of the group and activities are added to particular members' itineraries in which the particular members are likely to have an interest. Based on user-defined criteria, activities in the itineraries can be shared by the group as a whole or subgroups may be formed when the itineraries of some group members are assigned different activities.

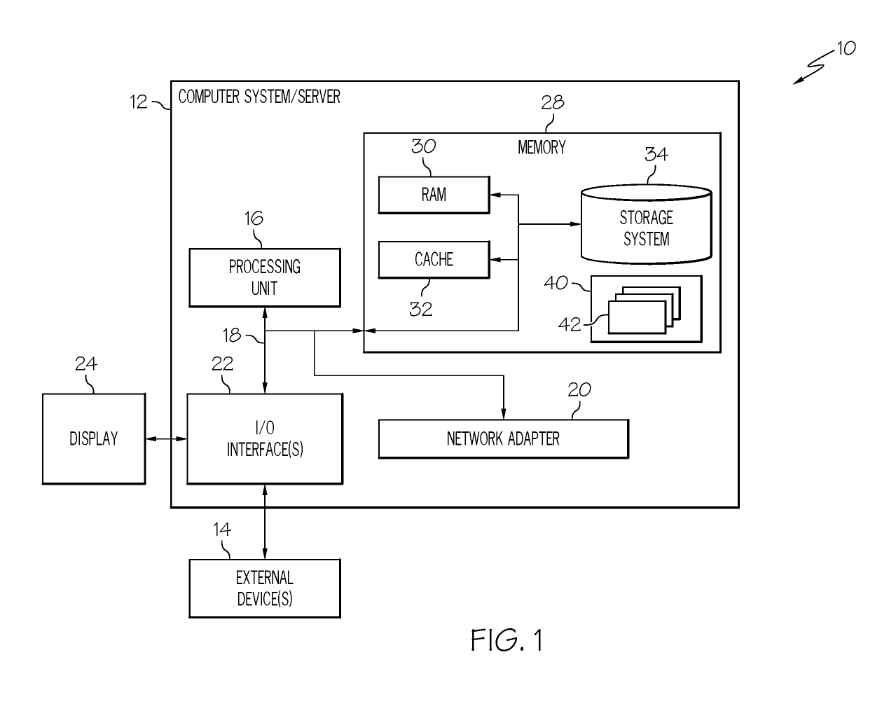

Referring now to FIG. 1, a computerized implementation 10 of an embodiment for developing interwoven group trip itineraries based on social media footprints will be shown and described. Computerized implementation 10 is only one example of a suitable implementation and is not intended to suggest any limitation as to the scope of use or functionality of embodiments of the invention described herein. Regardless, computerized implementation 10 is capable of being implemented and/or performing any of the functionality set forth hereinabove.

In computerized implementation 10, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

This is intended to demonstrate, among other things, that the present invention could be implemented within a network environment (e.g., the Internet, a wide area network (WAN), a local area network (LAN), a virtual private network (VPN), etc.), a cloud computing environment, a cellular network, or on a stand-alone computer system. Communication throughout the network can occur via any combination of various types of communication links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer system/server 12 is intended to demonstrate that some or all of the components of implementation 10 could be deployed, managed, serviced, etc., by a service provider who offers to implement, deploy, and/or perform the functions of the present invention for others.

Computer system/server 12 is intended to represent any type of computer system that may be implemented in deploying/realizing the teachings recited herein. Computer system/server 12 may be described in the general context of computer system/server executable instructions, such as program modules, being executed by a computer system. Generally, program modules may include routines, programs, objects, components, logic, data structures, and so on, that perform particular tasks or implement particular abstract data types. In this particular example, computer system/server 12 represents an illustrative system for developing interwoven group trip itineraries based on social media footprints. It should be understood that any other computers implemented under the present invention may have different components/software, but can perform similar functions.

Computer system/server 12 in computerized implementation 10 is shown in the form of a general-purpose computing device. The components of computer system/server 12 may include, but are not limited to, one or more processors or processing units 16, a system memory 28, and a bus 18 that couples various system components including system memory 28 to processing unit 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Processing unit 16 refers, generally, to any apparatus that performs logic operations, computational tasks, control functions, etc. A processor may include one or more subsystems, components, and/or other processors. A processor will typically include various logic components that operate using a clock signal to latch data, advance logic states, synchronize computations and logic operations, and/or provide other timing functions. During operation, processing unit 16 collects and routes signals representing inputs and outputs between external devices 14 and input devices (not shown). The signals can be transmitted over a LAN and/or a WAN (e.g., T1, T3, 56 kb, X.25), broadband connections (ISDN, Frame Relay, ATM), wireless links (802.11, Bluetooth, etc.), and so on. In some embodiments, the signals may be encrypted using, for example, trusted key-pair encryption. Different systems may transmit information using different communication pathways, such as Ethernet or wireless networks, direct serial or parallel connections, USB, Firewire, Bluetooth, or other proprietary interfaces. (All trademarks and trade names used herein are the property of their respective owners and are used for illustrative and descriptive purposes only.)

In general, processing unit 16 executes computer program code, such as program code for developing interwoven group trip itineraries based on social media footprints, which is stored in memory 28, storage system 34, and/or program/utility 40. While executing computer program code, processing unit 16 can read and/or write data to/from memory 28, storage system 34, and program/utility 40.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media, (e.g., VCRs, DVRs, RAID arrays, USB hard drives, optical disk recorders, flash storage devices, and/or any other data processing and storage elements for storing and/or processing data). By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program code embodied on a computer readable medium may be transmitted using any appropriate medium including, but not limited to, wireless, wireline, optical fiber cable, radio-frequency (RF), etc., or any suitable combination of the foregoing.

Program/utility 40, having a set (at least one) of program modules 42, may be stored in memory 28 by way of example, and not limitation. Memory 28 may also have an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a consumer to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

The inventors of the present invention have found that, even in a world where information is available at one's fingertips, some tasks, such as vacation, trip, and recreational activity planning are difficult and time consuming to accomplish. It is common to expend many hours planning a vacation, weekend getaway, or other trip. In particular, finding activities to do in new, exotic destinations can become a juggling act, especially when traveling in a group. When the entire traveling group is expected to jointly participate in each activity, someone is likely to be displeased at the activity, decreasing everyone's enjoyment. Therefore, the inventors of the present invention have found that it is at times desirable to split a travel group up for different activities, assigning everyone an activity that he or she will at least somewhat enjoy. However, it can be difficult to optimize splitting of the group and finding and prioritizing those activities which will most be enjoyed.

Accordingly, the inventors of the present invention have developed a system that divides up a traveling group and generates a personalized itinerary for each subgroup based on the group members' interests gathered from their social media profiles. Interests expressed on social media, such as through posts or pictures that people like, comments, tweets or re-tweets, social circles, and relationships can be used to match members of the group to other groups members with similar interests and then to find activities, such as places to stay or eat and attractions to see, for subgroups with similar interests.

Embodiments of the present invention offer several advantages for developing interwoven group trip itineraries based on social media footprints. For example, embodiments of the present invention allow for more efficient trip planning, reducing the time necessary to find activities that every member of a travel group will enjoy. Furthermore, embodiments of the present invention can be used to automate the trip planning process, requiring little direct user input to output a complete travel plan for each member of a travel group. Additionally, embodiments of the present invention can optimally divide members of a travel group into smaller groups whose members share similar interests, permitting these smaller groups to participate in activities that are most likely to be enjoyable for all members of the smaller group, and thereby increasing vacation satisfaction and enjoyment across the entire travel group.

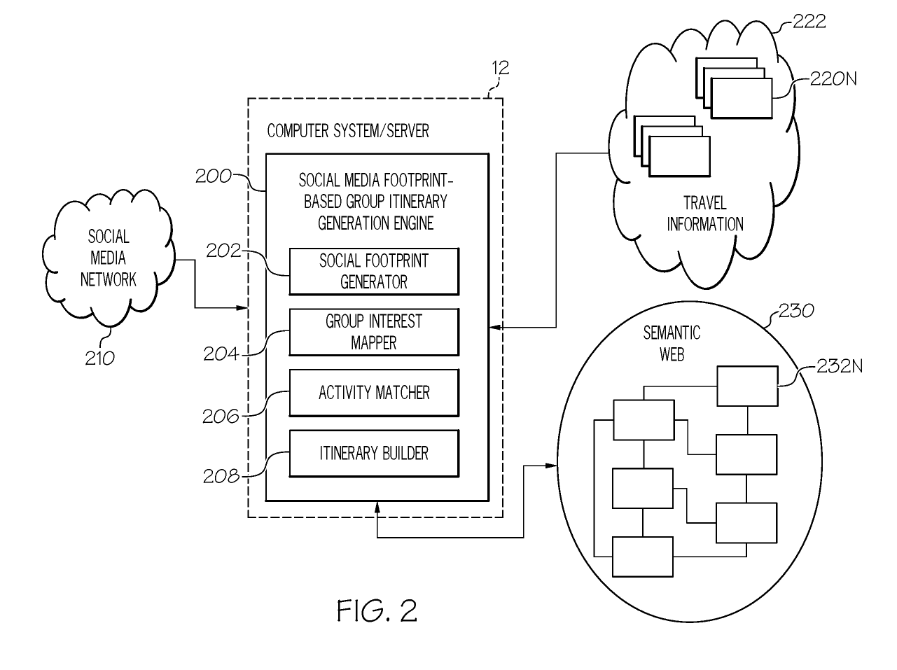

Referring now to FIG. 2, a system diagram describing the functionality discussed herein according to an embodiment of the present invention is shown. It is understood that the teachings recited herein may be practiced within any type of computing environment, including, but not limited to, a networked computing environment (e.g., a cloud computing environment). A stand-alone computer system/server 12 is shown in FIG. 2 for illustrative purposes only. In the event the teachings recited herein are practiced in a networked computing environment, each client need not have a social media footprint-based group itinerary generation engine 200 (hereinafter “system 200”). Rather, all or part of system 200 could be loaded on a server or server-capable device that communicates (e.g., wirelessly) with the clients to provide for developing interwoven group trip itineraries based on social media footprints. Regardless, as depicted, system 200 is shown within computer system/server 12. In general, system 200 can be implemented as program/utility 40 on computer system 12 of FIG. 1 and can enable the functions recited herein.

Along these lines, system 200 may perform multiple functions similar to a general-purpose computer. Specifically, among other functions, system 200 can generate interwoven group trip itineraries based on social media footprints of members of the group in a networked computing environment. To accomplish this, system 200 can include a set of components (e.g., program modules 42 of FIG. 1) for carrying out embodiments of the present invention. These components can include, but are not limited to, social footprint generator 202, group interest mapper 204, activity matcher 206, and itinerary builder 208.

Through computer system/server 12, system 200 can obtain social media activity information about users of social media network 210. Social media network can include, but is not limited to, any social media platform now known or later developed, such as, but not limited to, Facebook, LinkedIn, Google+, and/or Twitter. (All trademarks and trade names used herein are the property of their respective owners and are used for illustrative and descriptive purposes only.) System 200 can also obtain travel information on activities 220N from travel websites, tourism websites, local attractions websites, etc. or any other electronic travel activity information 222 located on a network (e.g., the Internet), to which system 200 is connected. System 200 can also be in communication with semantic web 230 containing systemically interconnected URIs 232N for associating social artifacts from social network 210 with travel activities 220N from the electronic travel activity information 222 on a network.

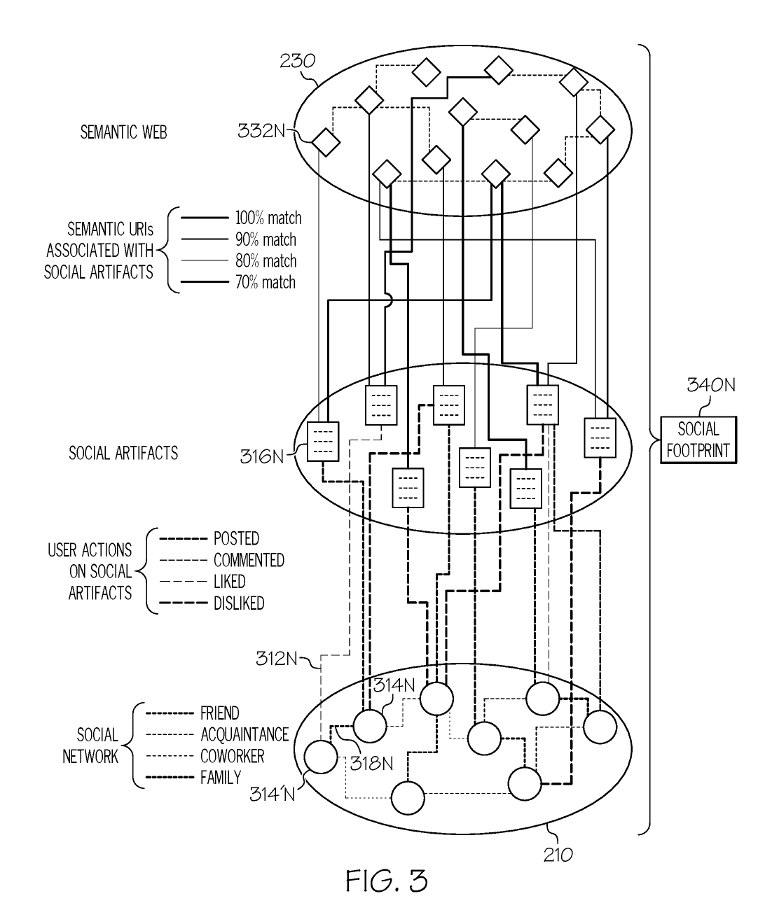

Referring now to FIG. 3 in connection with FIG. 2, leveraging a semantic web to map a social media user's travel interests footprint based on social media is shown. As will be further described below, social footprint generator 202 generates, for each person 314N of a plurality of people in a group, a travel interests footprint 340N based on a social media history of the person 314N. User 314N of social media network 210 may take actions 312N associated with social artifacts 316N within social media network 210 that reflect his/her personality and the things that interest him/her. A social artifact 316N is any digital item (e.g., a post, a comment, a picture, a web page, a document) on which a user of social media can action. Social media actions 312N associated with social artifacts 316N may include, for example, but are not limited to, liking a picture, commenting on a post, tweeting about something or re-tweeting someone else's post, following a celebrity, professional, or sports team, and/or the like. Additionally or in the alternative, user 314N may have social network connections 318N to another user 314N′ within social media network 210. This connection may have a strength rating based on a user-supplied closeness of the other user 314N′ to the user 314N or based on a number of mutual friends they have in common. Other user 314N′ may likewise take actions 312N associated with social artifacts 316N within social media network 210. In general, existing social media networks, such as social media network 210, may track and record all social media actions 312N and social network connections 318N as data which can be mined by social footprint generator 202.

In some embodiments, social footprint generator 202 of system 200, as performed by computer system/server 12, can obtain social media actions 312N and social network connections 318N from social media network 210. In such embodiments, social footprint generator 202 can associate each social artifact 316N with one or more semantic concepts represented by one or more semantic Uniform Resource Identifiers (URIs) 332N of semantic web 230. In some embodiments, social footprint generator 202 can assign different degrees of association between social artifacts 316N and URIs 332N. Such degrees of association may be represented by, for example, a percentage (e.g., 0-100%) or a tier (e.g., high, medium, low). URIs 332N may have different relationships between themselves that indicate how semantically similar the URIs are to one another. Based on the association of URIs 332N with social artifacts 316N, user 314N associated with particular social artifacts 316N can be associated with particular URIs 332N associated with those artifacts 316N.

In some embodiments, social footprint generator 202 can also associate user 314N with particular social artifacts 316N, and, by extension, with particular URIs 332N of other users 314N′ of social media network 210 connected to user 314N. This association may be based, for example, on a detected closeness of the connection between user 314N and other user 314N′. For example, it may be assumed that users who interact frequently have a greater closeness than users who interact infrequently or have never interacted. Alternatively, user 314N can supply social network 210 with a description of the relationship between user 314N and other user 314N′, such as a friend, a coworker, or an acquaintance. In any case, because people who are close often have similar interests, social footprint generator 202 may impute to user 314N the particular social artifacts 316N and particular URIs 332N of other users 314N′ who are closely connected to user 314N.

In some further embodiments, social footprint generator 202 can include travel referrals from other users 314N′ connected in social network 210 to user 314N as social artifacts 316N, and by extension URIs 332N, associated with user 314N. Such referrals can include interactions in social network 210 with social artifacts 316N associated with a location, an activity, or other travel attraction. For example, a referral can include, but is not limited to, another user 314N′ connected to user 314N on social network 210: liking (or disliking) a place he/she visited, checking into a place online, writing in an online forum about a place/activity, being a member of a group associated with a place/activity, leaving a positive (or negative) review about his/her experience at a place (e.g., a restaurant), visiting the same place (e.g., a hotel) multiple times, geo-tagging a post at a location (e.g., a tourist attraction), or posting pictures of a place he/she visited.

It should be understood that, in some alternative embodiments, social network 210, rather than social footprint generator 202, may perform the association of each social artifact 316N with the one or more semantic Uniform Resource Locators (URIs) 332N of semantic web 230 and, therefore, perform the associating of user 314N with particular URIs 332N based on user 314N being associated with particular artifacts 316N associated with the particular URIs 332N. In this case, social footprint generator 202 can obtain these semantic URIs 332N from social network 210 and, therefore, need not itself perform the association of social artifacts 316N with semantic URIs 332N.

From the association of user 314N with particular URIs 332N, social footprint generator 202 can build social footprint 340N of user 314N. Particularly, social footprint generator 202 can assign scores or weights to URIs 332N associated with user 314N based on a degree and recentness of interaction with the social artifacts 316N corresponding with URIs 332N. For example, a written comment or tweet may be scored or weighted more heavily than a mere “like” or re-tweet, because the former may be determined to indicate a greater degree of interest than the latter. Also, a more recent comment (e.g., a week-old comment) could be scored/weighted more heavily than a less recent comment (e.g., a comment from more than a year ago). Further, in cases in which the actions of other users 314N′ of social network 210 are associated with user 314N, these actions (and their corresponding URIs) can be scored or weighted based on the previously determined closeness of the users. These weighted scores can be accumulated for each URI 332N such that social footprint generator 202 can determine an interest score for each URI 332N in order to create a social footprint 340N. In some embodiments, the interest score for each URI 332N can be expressed as a percentage (e.g., 0-100%) of the scores for all URIs 332N combined. In other embodiments, the interest score for each URI 332N of URIs 332A-N can be expressed as a component of an interest vector having an element for each URI 332N in semantic web 230. In these embodiments, this interest vector can be normalized for comparison between different users 314N of social network 210. It should be understood that the interest scores for URIs 332N can change over time as user 314N interacts with different or new social artifacts 316N.

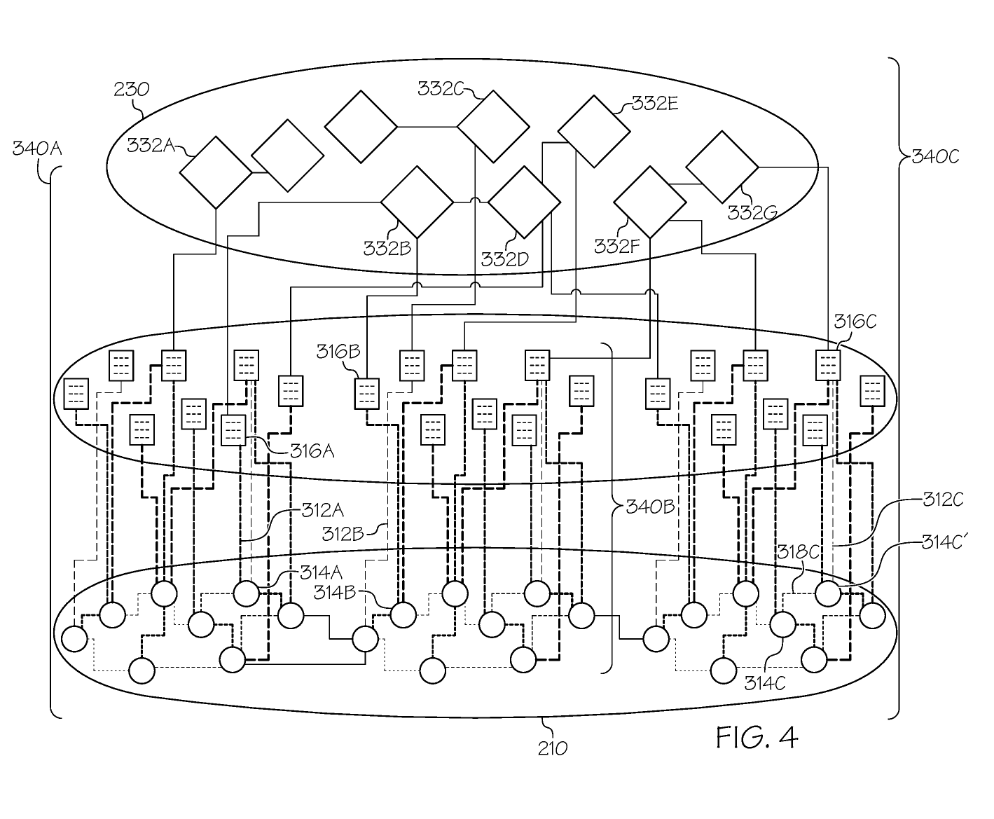

Referring now to FIG. 4 in connection with FIG. 2, an illustrative mapping of interests in a semantic web for a travel group of two or more people is shown. As will be further described below, group interest mapper maps a first travel interests footprint 340A of a first person 314A of the group to a first identifier 332A in a semantic web 230 associated with a first interest 316A in the first travel interests footprint 340A. Group interest mapper further maps a second travel interests footprint 340B of a second person 314B of the group to a second identifier 332B in the semantic web 230 associated with a second interest 316B in the second travel interests footprint 340B. This semantic web 230 comprises a plurality of identifiers 332A-N associated with interests 316A-N.

To accomplish this, group interest mapper 204 overlays social footprints 340A-N of several members (users 314A-N) of a travel group in semantic web 230, such that areas of interest of the members of the group overlap and interests that two or more group members have in common can be determined. In the illustrative example shown in FIG. 4, Owen is organizing a trip to New York City (NYC) for a group of 50 people through a local community library. Owen wants to provide the 50-person group going on the trip with itineraries of activities and places to visit in NYC that will make everyone in the travel group happy. To accomplish this goal, Owen may use system 200. System 200 obtains from Owen the identities of the people in the group, which in this illustrative example includes group members/social media users 314A (“Alex”), 314B (“Brett”), and 314C (“Cal”). Alex (314A) and Cal (314C) are acquaintances, while neither knows Brett (314B). Social footprint generator 202 generates social footprints 340A, 340B, and 340C for Alex (314A), Brett (314B), and Cal (314C), respectively, using the techniques described above with reference to FIG. 3.

These social footprints 340A-C can be mapped in the same semantic web 230 by group interest mapper 204. Group interest mapper 204 then identifies semantic URIs 332N with which one or more group members/social media users 314A-N are associated. Group interest mapper 204 determines that: Alex's (314A) interests correspond 10% with URI 332A representing history, 60% with URI 332B representing spectator sports, and 30% with URI 332D representing participant sports; Brett's (314B) interests correspond 40% with URI 332B representing spectator sports, 15% with URI 332C representing architecture, 30% with URI 332E representing yoga, and 15% with URI 332F representing television; and Cal's (314C) interests correspond 25% with URI 332D representing participant sports, 35% with URI 332F representing television, and 40% with URI 332G representing music. Based on this determination, group interest mapper 204 further determines that both Alex and Brett are interested in spectator sports (URI 332B, 60% and 40%, respectively), that both Alex and Cal are interested in participant sports (URI 332D, 30% and 25%, respectively), and that both Brett and Cal are interested in television (URI 332F, 15% and 35%, respectively).

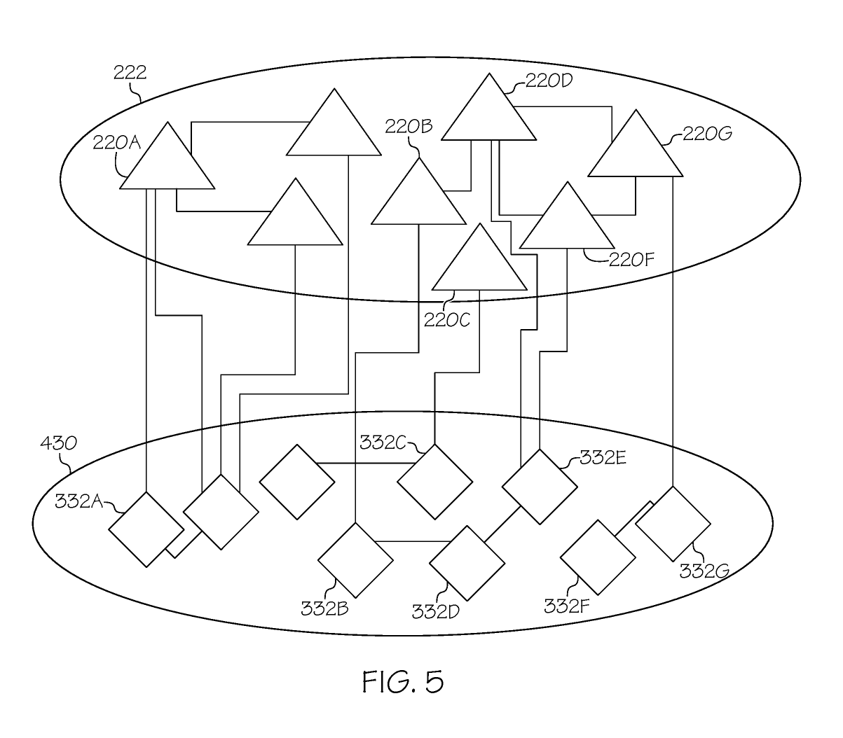

Referring now to FIG. 5 in connection with FIG. 2, an illustrative matching of interests represented in a semantic web to potential travel activities for a travel group of two or more people is shown. As will be further described below, activity matcher 206 obtains a plurality of activity options 220A-N based on a provided location and time. To accomplish this, system 200 can obtain criteria for the trip from a user of system 200 (e.g., a trip organizer). Such criteria can include, but is not limited to, dates of travel, time constraints, destination city/country/continent, radius limits within destination city/country/continent, maximum or minimum budget, etc. Based on the provided criteria, activity matcher 206 can research (e.g., by accessing a network) travel activity information 222, including activities, events, and places (e.g., to visit/eat/sleep) 220A-N, that conform to the criteria. In some embodiments, activity matcher 206 can access travel activity information 222 through application program interfaces (APIs) that correspond to information resources, such as travel websites, tourism websites, local attractions websites, third-party information and review websites, social media pages, etc.

As will be further described below, activity matcher 206 matches a first activity option 220A of the plurality of activity options 220A-N to the first identifier 332A and matches a second activity option 220B of the plurality of activity options 220A-N to the second identifier 332B. In some embodiments, as activity matcher 206 finds travel activity information 222, activity matcher 206 can place individual activities 220A-N in a semantic map of activities (each being assigned its own URI). This can permit activity matcher 206 to relate similar activities and thereby offer group members/social media users 314A-N several alternative activities. In this embodiment, travel referrals from other users 314N′ connected in social network 210 to user 314N that have been assigned a URI 332N in semantic web 230 can be assigned a URI in the semantic map of activities and be treated as a candidate activity for user 314N.

In some embodiments, activity matcher 206 can directly link individual activities 220A-N to interest URIs 332A-N of semantic web 230 by associating activities 220A-N with interest URIs 332A-N in sematic web 230. This association between activities and interests can be based on knowledge of the kinds of activities that are most likely to correspond well with certain interests. This knowledge can be based on, for example historic data, user feedback, and/or machine learning. In some embodiments, activity matcher 206 can perform, based on any of the above knowledge/information, a correlation between the plurality of activity options 220A-N and first and second identifiers 332A and 332B from semantic web 230. This correlation can include assessing, as a correlation value (e.g., a percentage, fraction, or other numerical value), the association between or relatedness of the interest indicated by semantic web identifier 332N and activity option 220N. In the case that the correlation value of activity 220N to interest URI 332N is above a predetermine threshold (e.g., pre-set by a user or determined by activity matcher 206 based on previous data) activity matcher 206 can match activity 220N to interest URI 332N.

Activity matcher 206 can then match each group members/social media users 314A-N with activities 220A-N he or she would likely enjoy based on the association of activities 220A-N with interest URIs 332A-N and the association of interest URIs 332A-N with group members/social media users 314A-N. The amount of activity interest a group member/social media user 314N is likely to have for activity 220N can be based on that user's interest score for interest URI 332N in a normalized interest vector (discussed above) that is associated with activity 220N. In some embodiments, group member/social media user 314N may be assigned the same level of interest for several activities 220A-N, such as in the case when several alternative activities are associated with the same URI 332N.

Continuing the illustrative example from above, system 200 obtains the following parameters from trip organizer, Owen: timeframe—Friday 8 p.m. to Sunday 2 p.m.; area—NYC. Activity matcher 206 searches tourism websites and other sources of travel activity information 222 to find, among others, the following activities during the provided timeframe in the provided area: museum visit 220A, baseball game 220B, skyscraper tour 220C, master yoga class 220D, late night TV show taping 220F, and Broadway musical 220G. Activity matcher 206 determines that a person who enjoys history would be likely to enjoy museum visit 220A, and therefore matches museum visit 220A to interest URI 332A, which represents an interest in history. Likewise, activity matcher 206 matches: baseball game 220B to an interest in spectator sports (URI 332B), skyscraper tour 220C to an interest in architecture (URI 332C), master yoga class 220D to an interest in participant sports (URI 332D) and yoga (URI 332E), late night TV show taping 220F to an interest in television (URI 332F), and Broadway musical 220G to an interest in music (URI 332G).

Activity matcher 206 also: associates each activity 220A-N with members of the travel group who are associated with interests URI 332A-N associated with those activities and weights this association between the group members and activities based on group members' interest vectors in the URIs. Therefore, activity matcher 206 assigns: museum visit 220A with a 10% interest weight for Alex (314A); baseball game 220B with a 60% interest weight for Alex and a 40% interest weight for Brett (314B); skyscraper tour 220C with a 15% interest weight for Brett; master yoga class 220D with a 30% interest weight for Alex, a 30% interest weight for Brett, and a 25% interest weight for Cal (314C); late night TV show taping 220F with a 35% interest weight for Cal; and Broadway musical 220G with a 40% interest weight for Cal.

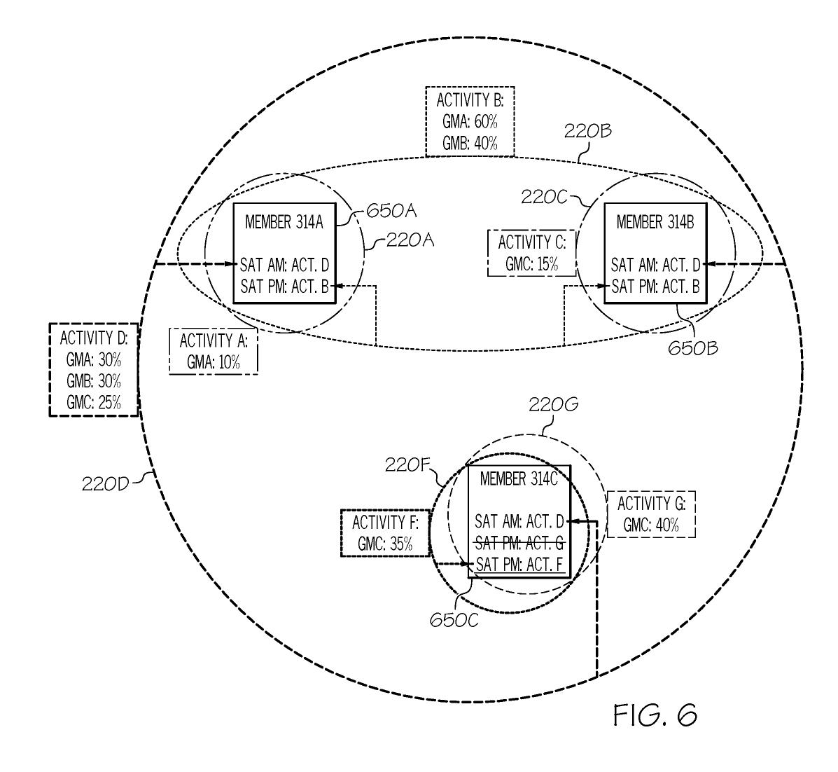

Referring now to FIG. 6 in connection with FIG. 2, an illustrative building of trip itineraries for subgroups of members of a travel group of two or more people is shown. As will be further described below, itinerary builder 208 builds a first itinerary 650A for the first person 314A and a second itinerary 650B for the second person 314B. Itinerary builder 208 builds the first itinerary 650A by adding the first activity 220A to the first itinerary 650A based on the association of the first identifier 332A to the first interest 316A in the first travel interests footprint 340A and on the matching of the first activity 220A to the first identifier 332A. Itinerary builder 208 builds the second itinerary 650B by adding the second activity 220B to the second itinerary 650B based on the association of the second identifier 332B to the second interest 316B in the second travel interests footprint 340B and on the matching of the second activity 220B to the second identifier 332B.

To accomplish this, itinerary builder 208 can map activities and group members' interests in the activities, as determined by activity matcher 206, to determine how best to assign activities to subgroups of group members within a larger group. In some embodiments, this determination can be based on one or more system user-defined priorities. Such priorities may include, but are not limited to, rules, such as: all activities must have more than X % interest for members assigned to them; each member must be assigned at least one activity in which he or she has at least an X % interest; no more than X subgroups; and each subgroup must have at least one adult chaperone (e.g., in the case of a school trip). Such priorities may also or alternatively include, but are not limited to, instructions, such as: assign activities with highest member interests for maximum number of members; minimize the number of subgroups; keep subgroups together throughout the day or permit subgroup hopping; give preference to children's interests over those of adults; and give preference to one or more specific members of the group.

Based on the one or more system user-defined priorities, itinerary builder 208 can split group member 314A-N into two or more subgroups that are each assigned a different activity 220A-N. For example, itinerary builder 208 can sort each of members 314A-N into a subgroup associated with the activity in which member 314N would be most interested in response to instructions from the user of system 200 to assign activities based on maximizing selection of activities 220A-N in which group members 314A-N are most interested. In another example, in response to instructions from the user of system 200 to limit the number of subgroups (e.g., to three), itinerary builder 208 can create several (e.g. three) subgroups and assign to each subgroup one of the activities 220A-N in which the majority of group members 314A-N in the subgroup are interested, sort those interested members into those subgroups, and assign each of the remaining members to the subgroup having an activity that most closely corresponds to an interest of the remaining member. In yet another example, itinerary builder 208 can determine the fewest number of subgroups associated with an activity that it can create, while making sure that, for each member, there is at least one subgroup assigned an activity in which that member has at least an X % interest in response to instructions from the user of system 200 to minimize the number of subgroups and also assign each member to an activity in which he or she has at least an X % interest.

At times, system 200 can receive instructions that the user of system 200 wants all members of a travel group to remain together or that all members of the group remain together for a portion of time (e.g., morning) and then be permitted to split up at a different time (e.g., afternoon). In this case, where all members of the travel group are to remain together, itinerary builder 208 assigns the group a single activity 220N. In order to find a single activity for the entire group, itinerary builder 208 can aggregate the interest vectors of all members 314A-N of the group to find the interest URIs 332A-N, and by extension activities 220A-N, that best correspond overall to the group. In some embodiments, this aggregation may merge the interest URIs 332A-N of all members 314A-N of the group into a normalized vector, combining each member's interest for each of URIs 332A-N to yield a total interest vector having a normalized score for each URI 332N. The URI 332N with the highest score is then used to match the group with an activity that would best be of interest to the group's members. In still other embodiments, the aggregation may be weighted, with interests URIs 332A-N associated with certain members (e.g., children, guest of honor, etc.) of the group being given a greater weight than those associated with other members of the group.

In any case, itinerary builder 208 can aggregate interest vectors (or social footprints 340A-N) of all group members 314A-N to find an activity 220N, that best corresponds to the group overall. For example, if system 200 receives instructions that the user of system 200 wants all members of the group to meet at noon for lunch at a restaurant, itinerary builder 208 can find a restaurant that best matches the interests of the group overall. Accordingly, system 200 can aggregate the food interests of each member of the group, determine in what type of restaurant the majority members of the group would be interested, and search for restaurants, within user-provided criteria, that correspond with the interests of the majority.

In some embodiments, itinerary builder 208 can aggregate interest vectors (or social footprints 340A-N) of all group members 314A-N into one or more aggregate vectors based on a similarity of URIs 332A-N within each individual vector. Accordingly, vectors of group members 314A-N differing (e.g., measured as less than X % difference) only by a few URIs or URI scores can be merged into an aggregate vector. Itinerary builder 208 can then find itineraries for each merged aggregate vector. In cases where the aggregated vector has little deviation, itinerary builder 208 can assign a shared itinerary between group members 314A-N or an itinerary that is the same for all group members. In cases where there is a moderate amount of deviation in the aggregated vector, itinerary builder 208 can assign some activities to group members 314A-N that are the same for each member in a portion of the itineraries, while assigning activities that are different across two or more group members in other portions of the itineraries. Therefore, in this case, group members 314A-N would each receive an itinerary that has some activities in common and some other activities not in common, such that the activities not in common reflect URIs specific to individual users that are points of deviation in the aggregated vector.

In further embodiments, system 200 can receive instructions that the user of system 200 wants to keep the travel group together unless a threshold is met for splitting the group apart. Such a group-split threshold could include, but is not limited to, one or more group members having less than a preset minimum interest in a group activity, the travel group exceeding a predetermined size or a maximum size for a particular activity, or one or more group members vetoing the activity to which the group is assigned and/or requesting to be scheduled for a different activity. For example, if itinerary builder 208 cannot find an activity in which all members of the travel group have at least an X % interest, itinerary builder 208 can search for a second activity in which members, who are less than X % interested in the first activity, are interested at least X %.

Based on the user-defined priorities and other criteria discussed above, itinerary builder 208 can develop a set of itineraries 650A-N for the members of the travel group. Itineraries 650A-N developed by itinerary builder 208 can cover any time duration (e.g., a short day trip of a few hours, a vacation lasting several days, etc.) desired by the user of system 200. In some embodiments, system 200 can receive instructions from the user of system 200 to build itineraries 650A-N based on blocks of time, with some blocks designated for a full-group activity 220N, while other blocks are designated to permit splitting of the travel group into subgroups so that members 314A-N of the travel group can simultaneously participate in different activities 220A-N. It should be understood that members that are placed in one subgroup, with a first set of other group members, for one activity can subsequently be placed in a different subgroup, with a second set of different other group members, for a second activity. In this way, itinerary builder 208 can develop tailored itineraries 650A-N (singular 650N) for each member 314A-N of the travel group, and each tailored itinerary 650N can be interwoven with itineraries 650A-N of other members of the travel group.

Once itinerary builder 208 has developed set of itineraries 650A-N for members 314A-N of the travel group, itineraries 650A-N can be distributed to the members 314A-N. In some embodiments, system 200 can perform this distribution directly to travel group members 314A-N. In other embodiments, system 200 can provide a user of system 200 (i.e., a trip organizer) with itineraries 650A-N for later distribution to group members 314A-N. Each member 314N may accept his or her itinerary 650N or may request that system 200 make one or more changes to his or her itinerary 650N. For example, group member 314N may reject one or more activities 220A-N contained in itinerary 650N or request that one or more activities 220A-N be replaced by an alternative activity 220N. In the case that group member 314N prefers an alternative activity, itinerary builder 208 can amend itinerary 650N of group member 314 to replace the unwanted activity 220N with a next best option activity. Selection of a next best option activity can be based on finding an activity that has the next highest interest score in the interest vector of group member 314N, or, alternatively, can be based on any other activity prioritization criteria earlier defined by the user of system 200.

It should also be understood that, when developing set of itineraries 650A-N, itinerary builder 208 can consider scheduling limitations associated with activities 220A-N, such as time and location distances, costs, available/open times, etc. For instance, itinerary builder 208 would not schedule two activities in a row for a group member 314N that would require the group member to travel a distance that cannot be traversed in the time between the activities. Such physical limitations in scheduling are generally understood, however, and therefore are not discussed in detail here.

Continuing the illustrative example from above, system 200 receives instructions from trip organizer, Owen, to develop interwoven itineraries 650A-C for the travel group based on one or more priorities and/or criteria. For example, system 200 may receive instructions that Owen, on one day of the trip, wants the travel group to participate in an activity as a whole group in the morning, provided that each group member has a least a 25% interest in the activity. Otherwise, the group should be split to ensure that all group members have at least a 25% interest in the activity they have been assigned in the morning. System 200 may further receive instructions that Owen wants the travel group to be split up in the afternoon into no more than three smaller subgroups that place the maximum number of group members in activities in which they are the most likely to be interested. Based on these criteria and priorities, itinerary builder 208 can develop interwoven itineraries 650A-C in which Alex (314A), Brett (314B), and Cal (314C) participate in master yoga class 220D in the morning. Itinerary builder 208 selects this activity because activity 220D allows all of the travel group to remain together, thereby meeting Owen's group activity criteria, because each of Alex, Brett, and Cal have at least a 25% interest, as determined earlier, in this activity, thereby meeting Owen's minimum interest criteria, and because aggregated social footprints 340A-C of Alex, Brett, and Cal point to activity 220D as the activity in which all group members are interested that has the highest cumulative normalized score when aggregated in an interest vector.

Further, following the provided criteria and priorities, itinerary builder 208 develops interwoven itineraries 650A-C to place Alex and Brett, as a subgroup, at baseball game 220B in the afternoon, while splitting Cal from the travel group into Cal's own subgroup, which is assigned to attend Broadway musical 220G. Itinerary builder 208 selects baseball game 220B for Alex and Brett because it is the activity in which they are both most likely to be interested based on their interest scores for activity 220B. Likewise, itinerary builder 208 selects Broadway musical 220G for Cal because it is the activity in which Cal is most likely to be interested based on Cal's interest score for activity 220G.

After itinerary builder 208 completes development of itineraries 650A-C, itineraries 650A-C are given to Alex, Brett, and Cal. Alex and Brett receive itineraries 650A and 650B scheduling them for master yoga class 220D in the morning and baseball game 220B in the afternoon. Cal receives itinerary 650C scheduling Cal for master yoga class 220D in the morning and Broadway musical 220G in the afternoon. Cal dislikes the idea of going to Broadway musical 220G and rejects itinerary 650C for this reason. Itinerary builder 208 then amends Cal's itinerary 650C, replacing Broadway musical 220G with late night TV show taping 220F. Cal approves this amended itinerary 650C. Now, Alex, Brett, and Cal have each been provided with itinerary 650A, 650B, and 650C, respectively, that is interwoven with the itineraries 650A-N of the other members of the travel group.

It should be understood that, although the working example used above to illustrate embodiments of the present invention features a travel group having only three members, travel groups of any size are within the scope of embodiments of the present invention. Accordingly, the size of the example travel group should not be construed as limiting.

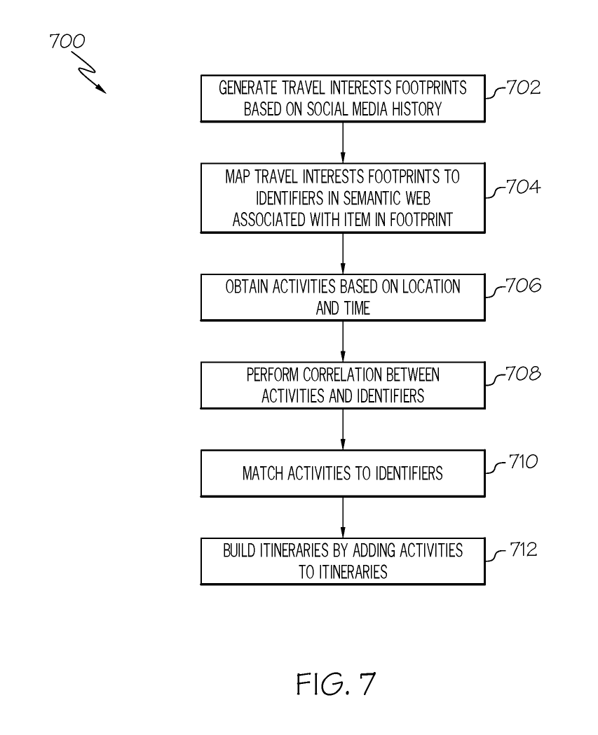

As depicted in FIG. 7, in one embodiment, a system (e.g., computer system/server 12) carries out the methodologies disclosed herein. Shown is a process flowchart 700 for developing interwoven group trip itineraries based on social media footprints. At 702, social footprint generator 202 generates, for each person 314N of a plurality of people in a group, a travel interests footprint 340N based on a social media history of the person 314N. At 704, group interest mapper maps a first travel interests footprint 340A of a first person 314A of the group to a first identifier 332A in a semantic web 230 associated with a first interest 316A in the first travel interests footprint 340A, the semantic web 230 comprising a plurality of identifiers 332A-N associated with interests 316A-N, and group interest mapper maps a second travel interests footprint 340B of a second person 3146 of the group to a second identifier 332B in the semantic web 230 associated with a second interest 316B in the second travel interests footprint 340B. At 706, activity matcher 206 obtains a plurality of activity options 220A-N based on a provided location and time. At 708, activity matcher 206 performs a correlation between the plurality of activity options 220A-N and the first and second identifiers 332A and 332B in the semantic web 230. At 710, activity matcher 206 matches, in response to a first correlation value above a threshold, a first activity option 220A of the plurality of activity options 220A-N to the first identifier 332A and matches, in response to a second correlation value above a threshold, a second activity option 220B of the plurality of activity options 220A-N to the second identifier 332B. At 712, itinerary builder 208 builds a first itinerary 650A for the first person 314A and a second itinerary 650B for the second person 314B by: adding the first activity 220A to the first itinerary 650A based on the association of the first identifier 332A to the first interest 316A in the first travel interests footprint 340A and on the matching of the first activity 220A to the first identifier 332A and adding the second activity 220B to the second itinerary 650B based on the association of the second identifier 332B to the second interest 316B in the second travel interests footprint 340B and on the matching of the second activity 220B to the second identifier 332B.

Process flowchart 700 of FIG. 7 illustrates the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Some of the functional components described in this specification have been labeled as systems or units in order to more particularly emphasize their implementation independence. For example, a system or unit may be implemented as a hardware circuit comprising custom VLSI circuits or gate arrays, off-the-shelf semiconductors such as logic chips, transistors, or other discrete components. A system or unit may also be implemented in programmable hardware devices such as field programmable gate arrays, programmable array logic, programmable logic devices, or the like. A system or unit may also be implemented in software for execution by various types of processors. A system or unit or component of executable code may, for instance, comprise one or more physical or logical blocks of computer instructions, which may, for instance, be organized as an object, procedure, or function. Nevertheless, the executables of an identified system or unit need not be physically located together, but may comprise disparate instructions stored in different locations which, when joined logically together, comprise the system or unit and achieve the stated purpose for the system or unit.

Further, a system or unit of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices and disparate memory devices.

Furthermore, systems/units may also be implemented as a combination of software and one or more hardware devices. For instance, program/utility 40 may be embodied in the combination of a software executable code stored on a memory medium (e.g., memory storage device). In a further example, a system or unit may be the combination of a processor that operates on a set of operational data.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Any of the components provided herein can be deployed, managed, serviced, etc., by a service provider that offers to deploy or integrate computing infrastructure with respect to a process for developing interwoven group trip itineraries based on social media footprints. Thus, embodiments herein disclose a process for supporting computer infrastructure, comprising integrating, hosting, maintaining, and deploying computer-readable code into a computing system (e.g., computer system/server 12), wherein the code in combination with the computing system is capable of performing the functions described herein.

In another embodiment, the invention provides a method that performs the process steps of the invention on a subscription, advertising, and/or fee basis. That is, a service provider, such as a Solution Integrator, can offer to create, maintain, support, etc., a process for developing interwoven group trip itineraries based on social media footprints. In this case, the service provider can create, maintain, support, etc., a computer infrastructure that performs the process steps of the invention for one or more customers. In return, the service provider can receive payment from the customer(s) under a subscription and/or fee agreement, and/or the service provider can receive payment from the sale of advertising content to one or more third parties.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is apparent that there has been provided herein approaches to develop interwoven group trip itineraries based on social media footprints. While the invention has been particularly shown and described in conjunction with exemplary embodiments, it will be appreciated that variations and modifications will occur to those skilled in the art. Therefore, it is to be understood that the appended claims are intended to cover all such modifications and changes that fall within the true spirit of the invention.

What is claimed is:

1. A method for developing interwoven group trip itineraries based on social media footprints, the method comprising:
generating, for each person of a plurality of people in a group, a travel interests footprint based on a social media history of the person;
mapping a first travel interests footprint of a first person of the group to a first identifier in a semantic web associated with a first interest in the first travel interests footprint, the semantic web comprising a plurality of identifiers associated with interests;
mapping a second travel interests footprint of a second person of the group to a second identifier in the semantic web associated with a second interest in the second travel interests footprint;
obtaining a plurality of activity options based on a provided location and time;
performing a correlation between the plurality of activity options and the first and second identifiers in the semantic web;
matching, in response to a first correlation value above a threshold, a first activity option of the plurality of activity options to the first identifier and matching, in response to a second correlation value above the threshold, a second activity option of the plurality of activity options to the second identifier; and
building a first itinerary for the first person and a second itinerary for the second person by: adding the first activity option to the first itinerary based on the association of the first identifier to the first interest in the first travel interests footprint and on the matching of the first activity option to the first identifier and adding the second activity option to the second itinerary based on the association of the second identifier to the second interest in the second travel interests footprint and on the matching of the second activity option to the second identifier.

2. The method of claim 1, the method further comprising generating an interest score for the first person in the first identifier associated with the first interest based on a degree of significance of the first interest in the generated first travel interests footprint.

3. The method of claim 2, the method further comprising assigning the first activity option an interest score for the first person based on the generated interest score for the first person in the first identifier.

4. The method of claim 3, the method further comprising:
assigning the second activity option an interest score for the first person based on a generated interest score for the first person in the second identifier associated with the second interest based on a degree of significance of the second interest in the generated first travel interests footprint; and
selecting the first activity option over the second activity option to add to the first itinerary for the first person based on the interest score for the first activity option being greater than the interest score for the second activity option.

5. The method of claim 1, the method further comprising:
receiving a person grouping criteria comprising a condition;
determining whether the condition has been met;
adding a same activity option to the first itinerary and the second itinerary in the case that the condition has been met; and
adding different activities to the first itinerary and the second itinerary in the case that the condition has not been met.

6. The method of claim 1, the first itinerary and the second itinerary each comprising a plurality of time blocks, each time block being associated with a criteria and a condition, the method further comprising:
determining, for each time block, whether the associated condition has been met;
adding, in the case that the condition has been met for a time block of the plurality of time blocks, to each of the first and second itineraries, an activity option of the plurality of activity options that corresponds with the criteria; and
adding, in the case that the condition has not been met for a time block of the plurality of time blocks, to each of the first and second itineraries, an activity option of the plurality of activity options that does not correspond with the criteria.

7. The method of claim 1, the adding the first activity option to the first itinerary and the adding the second activity option to the second itinerary being further based on a predefined priority comprising a rule that resolves a conflict between two or more alternative activity options.

8. A computer system for developing interwoven group trip itineraries based on social media footprints, the computer system comprising:
a memory medium comprising program instructions;
a bus coupled to the memory medium; and
a processor, for executing the program instructions, coupled to a social media footprint-based group itinerary generation engine via the bus that when executing the program instructions causes the system to:
generate, for each person of a plurality of people in a group, a travel interests footprint based on a social media history of the person;
map a first travel interests footprint of a first person of the group to a first identifier in a semantic web associated with a first interest in the first travel interests footprint, the semantic web comprising a plurality of identifiers associated with interests;
map a second travel interests footprint of a second person of the group to a second identifier in the semantic web associated with a second interest in the second travel interests footprint;
obtain a plurality of activity options based on a provided location and time;
perform a correlation between the plurality of activity options and the first and second identifiers in the semantic web;
match, in response to a first correlation value above a threshold, a first activity option of the plurality of activity options to the first identifier and match, in response to a second correlation value above a threshold, a second activity option of the plurality of activity options to the second identifier; and
build a first itinerary for the first person and a second itinerary for the second person by: adding the first activity option to the first itinerary based on the association of the first identifier to the first interest in the first travel interests footprint and on the matching of the first activity option to the first identifier and adding the second activity option to the second itinerary based on the association of the second identifier to the second interest in the second travel interests footprint and on the matching of the second activity option to the second identifier.

9. The computer system of claim 8, the instructions further causing the system to generate an interest score for the first person in the first identifier associated with the first interest based on a degree of significance of the first interest in the generated first travel interests footprint.

10. The computer system of claim 9, the instructions further causing the system to assign the first activity option an interest score for the first person based on the generated interest score for the first person in the first identifier.

11. The computer system of claim 10, the instructions further causing the system to:
assign the second activity option an interest score for the first person based on a generated interest score for the first person in the second identifier associated with the second interest based on a degree of significance of the second interest in the generated first travel interests footprint; and
select the first activity option over the second activity option to add to the first itinerary for the first person based on the interest score for the first activity option being greater than the interest score for the second activity option.

12. The computer system of claim 8, the instructions further causing the system to:
receive a person grouping criteria comprising a condition;
determine whether the condition has been met;
add a same activity option to the first itinerary and the second itinerary in the case that the condition has been met; and
add different activities to the first itinerary and the second itinerary in the case that the condition has not been met.

13. The computer system of claim 8, wherein the first itinerary and the second itinerary each comprise a plurality of time blocks, each time block being associated with a criteria and a condition, the instructions further causing the system to:
determine, for each time block, whether the associated condition has been met;
add, in the case that the condition has been met for a time block of the plurality of time blocks, to each of the first and second itineraries, an activity option of the plurality of activity options that corresponds with the criteria; and
add, in the case that the condition has not been met for a time block of the plurality of time blocks, to each of the first and second itineraries, an activity option of the plurality of activity options that does not correspond with the criteria.

14. The computer system of claim 8, the instructions further causing the system to add the first activity option to the first itinerary and add the second activity option to the second itinerary based on a predefined priority comprising a rule that resolves a conflict between two or more alternative activity options.

15. A computer program product for developing interwoven group trip itineraries based on social media footprints, the computer program product comprising a computer readable hardware storage device, and program instructions stored on the computer readable hardware storage device, to:
generate, for each person of a plurality of people in a group, a travel interests footprint based on a social media history of the person;
map a first travel interests footprint of a first person of the group to a first identifier in a semantic web associated with a first interest in the first travel interests footprint, the semantic web comprising a plurality of identifiers associated with interests;
map a second travel interests footprint of a second person of the group to a second identifier in the semantic web associated with a second interest in the second travel interests footprint;
obtain a plurality of activity options based on a provided location and time;
perform a correlation between the plurality of activity options and the first and second identifiers in the semantic web;
match, in response to a first correlation value above a threshold, a first activity option of the plurality of activity options to the first identifier and match, in response to a second correlation value above a threshold, a second activity option of the plurality of activity options to the second identifier; and
build a first itinerary for the first person and a second itinerary for the second person by: adding the first activity option to the first itinerary based on the association of the first identifier to the first interest in the first travel interests footprint and on the matching of the first activity option to the first identifier and adding the second activity option to the second itinerary based on the association of the second identifier to the second interest in the second travel interests footprint and on the matching of the second activity option to the second identifier.

16. The computer program product of claim 15, the computer readable storage device further comprising instructions to generate an interest score for the first person in the first identifier associated with the first interest based on a degree of significance of the first interest in the generated first travel interests footprint.

17. The computer program product of claim 16, the computer readable storage device further comprising instructions to assign the first activity option an interest score for the first person based on the generated interest score for the first person in the first identifier.

18. The computer program product of claim 17, the computer readable storage device further comprising instructions to:
assign the second activity option an interest score for the first person based on a generated interest score for the first person in the second identifier associated with the second interest based on a degree of significance of the second interest in the generated first travel interests footprint; and
select the first activity option over the second activity option to add to the first itinerary for the first person based on the interest score for the first activity option being greater than the interest score for the second activity option.

19. The computer program product of claim 15, the computer readable storage device further comprising instructions to:
receive a person grouping criteria comprising a condition;
determine whether the condition has been met;
add a same activity option to the first itinerary and the second itinerary in the case that the condition has been met; and
add different activities to the first itinerary and the second itinerary in the case that the condition has not been met.

20. The computer program product of claim 15, wherein the first itinerary and the second itinerary each comprise a plurality of time blocks, each time block being associated with a criteria and a condition, the computer readable storage device further comprising instructions to:
determine, for each time block, whether the associated condition has been met;
add, in the case that the condition has been met for a time block of the plurality of time blocks, to each of the first and second itineraries, an activity option of the plurality of activity options that corresponds with the criteria; and
add, in the case that the condition has not been met for a time block of the plurality of time blocks, to each of the first and second itineraries, an activity option of the plurality of activity options that does not correspond with the criteria.
